(19) United States
(12) Patent Application Publication
(10) Pub. No.: US 2002/0078347 A1
(43) Pub. Date: Jun. 20, 2002

(54) Method and system for using with confidence certificates issued from certificate authorities

(75) Inventors: Olivier Hericourt, La Gaude (FR); Jean-Francois Le Pennec, Nice (FR)

Correspondence Address: David R. Irvin, IBM Corporation T81/503, PO Box 12195, Research Triangle Park, NC, 27709, US

(73) Assignee: International Business Machines Corporation, Armonk, NY (US)

(21) Appl. No.: 10/007,750

(22) Filed: Nov. 13, 2001

(30) Foreign Application Priority Data
Dec. 20, 2000 (EP) 00480125.4

(51) Int. Cl. H04L 9/00

(52) U.S. Cl. 713/156

(57) ABSTRACT

A system and method in a workstation connected to a network for verifying the trustworthiness of a certificate issued by a certificate authority. A certificate from a certificate authority is received and held in storage pending verification. The purported identity of the certificate authority is determined, and sent to a certificate authority filter. The filter returns information regarding the purported certificate authority and the public key of the certificate authority. The trustworthiness of the certificate authority is determined by reference to the information returned by the filter and by verifying the signature of the certificate using the public key.

### FIELD OF THE INVENTION

The present invention relates to the security of communications between computer devices, and more particularly to a method and system for using, with confidence and trust, certificates issued from Certificate Authorities (CA).

### BACKGROUND

Among many issues concerning computing and networking security, one important cause of concern relates to the identity of communicating entities. When a user communicates with a remote entity (for instance another user or any computer), it is very important to be confident of the identity of the remote entity. For instance, a user who wishes to send confidential information related to his credit card to a particular bank, wants to be sure that such critical information will not be sent to someone else pretending to be his bank. Most current methods for certifying an identity of an entity (such as a user, a company, a computer device) are based on “Certificates”.

The security of a certifying method depends on the degree of confidence or trust that the user can associate with the Certificate. Fundamentally, this degree of confidence depends on whether the public key element of the Certificate is really “owned” by the entity defined in the “Subject Name” field of the certificate. Consequently, user Certificates are signed by a third party called a Certificate Authority (CA), which attests to the rightful ownership of the public key.

A Certificate verification process checks that the Certificate has actually been signed by the CA. This process therefore relies on the user who has obtained the CA Certificate in order to retrieve the CA public key. Frequently CA Certificates are issued in the form of a self-signed Certificate. A self-signed CA Certificate cannot be directly trusted because it is signed with the public key of the CA and is not signed by another trusted CA. The CA's public key is signed using the corresponding CA private key. While this process ensures the integrity of a Certificate, it does not provide any protection concerning its authentication. Any entity can generate a key pair and create a self-signed certificate that can pretend to be, for instance, a Verisign CA Certificate. Therefore, the user needs to trust the CA Certificate and to be sure that the CA Certificate comes from a known source.

In some situations, the user wants to communicate with another entity that has a Certificate issued by a CA that he doesn't know and that is different from his own issuing CA. In such a situation, the user must retrieve the Certificate of the CA that has issued the Certificate of the entity. There are three main techniques, with various degrees of confidence as explained below:

Known Web Site. This is the weakest method. The user downloads the CA trusted Certificate from a known web site. Then, the user can load the trusted Certificate into the appropriate trusted certificate database. The vulnerability of this method is the following: the web site can be either spoofed or hacked and a false CA Certificate can be substituted for the legitimate one. The user is then liable to attacks when he receives false user Certificates.

Embedded Certificates. This technique is prevalent for web Browsers. Most web Browsers are pre-loaded with trusted public keys/Certificates, for instance Verisign CA Certificates. This technique is more secure than the Known Web Site technique. However, the user depends on a CA prescribed by the web Browser. This technique is well adapted to “personal” users, however it lacks flexibility for tradespeople or enterprises. For instance, the user is obliged to support the CA prescribed by the web Browser and also to support its topology. Furthermore, if the CA's private key is compromised (has been discovered for instance), it will be necessary to load a new CA trusted Certificate. Some enterprises wish to have the CA under their administrative control—which is clearly not possible in this situation.

Secure Delivery. This method is the most secure, and it provides some form of flexibility. In this case, the CA Certificate (or just the public key) is provided to the user through an alternate secure channel. This alternate secure channel is for instance a physical mail or an electronic mail via a specially encrypted communications channel. However, this method is generally complex to implement.

In most common situations, when a user retrieves a new CA Certificate during a communication with another entity (for instance another user), he must specify whether or not he accepts this new CA Certificate. Generally, the user accepts the new CA Certificate without really knowing if he can trust it, simply because he wants to continue the communication. This is a breach of security, because this CA may be malicious and may attack the user.

The problem is then to ensure the trustworthiness of a CA Certificate, and to prevent acceptance of an untrustworthy CA Certificate.

A Certificate is a structure that contains a public value (i.e. a public key) associated with an identity. For instance, within a X.509 Certificate, the public key is bound to a “user's name” (a “user's name” can be for instance the name of a physical person or can be the name of any device or computer which has an identity). A third party (a Certificate Authority) attests that the public key belongs to the user. As shown in FIG. 1, an X.509 Certificate is a formal structure that comprises a number of elements:

Subject (101): This is the “user's name” (the Subject can be any identity value).

Issuer (102): This is the name of the third party that has issued/generated the Certificate. This third party is the Certificate Authority (CA).

Public Key Value (103): This is the public key of a public/private key pair. An associated field defines the public key algorithm that must be used, for instance an RSA, Diffie-Hellman, or DSA public key.

Validity (104): Two fields are used to define the period of validity (valid from date 1 and valid to date 2).

Serial Number (105): This field provides a unique Certificate serial number for the issuer.

Signature (106): The signature is an encrypted digest generated by the Certificate Authority (CA) for authenticating the whole Certificate. The digest results from the hashing of the Certificate. The digest is encrypted using the CA private key. The encrypted digest, which is the signature, “certifies” that the Subject is the “owner” of the public and private keys.

The Certificate must be verified to ensure that it is valid. This is a complex process. Verification by an end user of a Certificate comprises the checking of the following elements:

Valid (or any) Subject and Issuer names are defined in the Certificate.

The Certificate is not expired (checking of the Validity period field).

The Certificate has not been revoked (this may be determined by obtaining a current Certificate Revocation List from the CA).

The signature on the Certificate is valid (the signature is not verified by using the Certificate's public key but by using the CA public key).

The method for validating the signature is quite simple, and comprises the steps of:

extracting the issuer's name (CA name) from the Certificate;

locating the issuer's Certificate (CA Certificate) or the issuer's public key (CA public key); and

checking that the end user's Certificate signature was generated by the issuer (CA) using the issuer's public key (CA public key).

Certificates are generated by a Certificate Authority (CA). One of two methods is normally used:

Centralized Generation: The private/public key pair is generated by the end user (defined in the subject field of the Certificate). The public key is directly provided by the end user to the CA software to create a Certificate. The Certificate can be provided to another end user via any suitable channel. The channel does not have to be secure because a Certificate is a self protecting structure (given the CA's signature).

Distributed Generation: The private/public key pair is generated by the end user. The end user requests the CA to build a Certificate including the end user public key. The public key is then sent to the CA for certification. If the request is valid then the CA returns a Certificate associating the user identity with the user public key to the end user.

Of course these two methods can be combined in any system, because trusted CA keys are generated by the Certificate Authority (CA).

Centralized Generation of Certificate

Techniques that can be used include:

Manual Distribution: In this case the user is registered on the CA (or associated Registration Authority) by an administrator. According to the enterprise's security policy, the user can declare himself and request a Certificate to the administrator of the CA. The process of registering the user may include the creation of a token. The token contains the user's Certificate and the associated private key. The token is physically supplied to the user. The token can take the form of a disk file or a smart card. For more security, a security PIN code can be used to “unlock” the token. If a PIN system is implemented, then it is then possible to mail the token to the user—physically or even electronically. However, the PIN should always be sent to the user by means of a separate secure physical method. Once the user has received the Certificate, he can use its public key to provide security services. This technique does not require a permanent connection between the users and the Certificate Authority (CA).

Request: Typically, to request a Certificate (or in Verisign's parlance a Digital ID), the user uses a web Browser to access a CA's web page. The user is invited to enter some personal information, primarily for identification purposes. The user is also invited to enter some form of Password. After having requested the Certificate (and also triggered the central generation of the public/private key pair), the user typically receives an e-mail with details on the way to fetch the Certificate. Generally this e-mail contains the URL (Uniform Resource Locator) of a web page that the user must visit to fetch the Certificate. When the user visits the web site, he is invited to enter the Password (or something derived from it). The Certificate is then sent to the user using an HTTP (Hypertext Transfer Protocol) message that the Web Browser can recognize and can enter in its Certificate database. The user must also receive the CA's Trusted Public Key. Most Browsers are preloaded with some trusted public keys, for instance Versign's. If the CA's trusted public key is not installed within the web Browser, then a similar operation can be used to fetch it.

Request—with authentication: This technique is very similar to the previous one (Request). In an additional step, authentication checks are made. Typically, off-line security checks are performed on some of the requester's personal information. This technique is particularly adapted to commercial communications where a higher level of confidence in the Certificate is required.

Distributed Generation of Certificate

In this method, the key material is generated by the user, and the public key is sent to the CA for signature and for creation of the Certificate. A standalone public key is vulnerable to tampering because no identity is securely associated with it. Therefore some techniques are designed to protect the public key in the transmission from the user to the CA.

### SUMMARY OF THE INVENTION

The present invention relates to the security of communications between computer devices, and more particularly to a method and system for using, with confidence and trust, certificates issued by Certificate Authorities (CA).

The present invention discloses a system and method, in a workstation connected to a network, for filtering certificates issued from one or more certificate authorities (CA). The method comprises the steps of:

receiving a certificate and storing the certificate;

preventing the use of the certificate until validation;

identifying the certificate authority (CA) that has issued the certificate;

verifying whether or not the identified certificate authority (CA) is a trusted certificate authority, which includes the further steps of:

identifying one or more certificate authority filters (CAF) referring to a table (CFC table), the table comprising an identification of one or more certificate authority filters;

sending a request to one or more of the identified certificate authority filters;

receiving from each certificate authority filter a response to the request, the response comprising information related to the certificate authority that has issued the certificate and depending on the information in a public key;

determining according to the responses whether or not the certificate authority is a trusted certificate authority; and

validating the certificate if the certificate authority (CA) that has issued the certificate is a trusted certificate authority.

The present invention also discloses a system and method, in a certificate authority filter connected to a network, for filtering certificates issued from one or more certificate authorities (CA). The method comprises the steps of:

receiving a request comprising an identification of a certificate authority (CA);

identifying the certificate authority (CA) in the request;

identifying in a table (CAF table) the certificate authority identified in the request, the table comprising:

the identification of one or more certificate authorities; and

a level of trust and a public key associated with each of the of certificate authorities;

determining the level of trust of the identified certificate authority (CA) referring to the table;

retrieving the public key associated with the identified certificate authority (CA) referring to the table; and

sending a response to the originator of the request, said response comprising the level of trust of the certificate authority identified in the request and the public key associated with the certificate authority.

### BRIEF DESCRIPTION OF THE DRAWINGS

The invention will best be understood by reference to the following detailed description of an illustrative detailed embodiment when read in conjunction with the accompanying drawings, wherein:

FIG. 1 describes the structure of a Certificate, according to prior art.

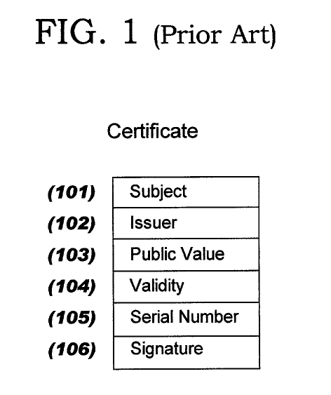

FIG. 2 shows the use of Certificates between two entities, according to prior art.

FIG. 3 describes the different entities involved in the present invention.

FIG. 4 describes the internal logic of the Certificate Checker according to the present invention.

FIG. 5 describes the CA Filter Table according to the present invention.

FIG. 6 describes the Certificate Checker Table according to the present invention.

FIG. 7 describes the internal logic of the CA Filter according to the present invention.

### DETAILED DESCRIPTION

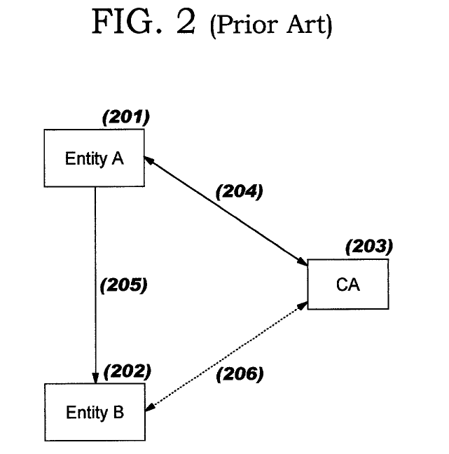

FIG. 2 shows the use of Certificates between two entities, according to prior art. When an Entity A (201) (for instance a user or any computer device) wants to send a message to an Entity B (202), the following steps occur:

The Entity A (201) retrieves (204) a Certificate (with Entity A as “Subject”) from its Certificate Authority (CA) (203). The CA is the “issuer” of this Certificate. The Certificate is used by the Entity B to authenticate messages sent by Entity A. The Certificate can be retrieved by Entity B from the CA or sent by Entity A.

The Entity A locally stores the retrieved Certificate. The private key associated with this Certificate will be used to sign all messages that will be sent later.

The Entity A (201) sends (205) a message to Entity B (202) along with the retrieved Certificate if Entity B has not already retrieved the Certificate from the CA.

The Entity B (202) receives (205) the signed message from Entity A.

The Entity B identifies the CA that has issued the received Certificate (203), using the Issuer (102) field of the Certificate.

If the Entity B does not have the Certificate of the CA locally available (for instance stored in a local cache), it retrieves (206) this CA Certificate from the CA.

The Entity B then authenticates the Entity A (Entity B makes sure of the identity of Entity A) using the Certificate received either from Entity A with the message or separately from the CA; and the CA Certificate.

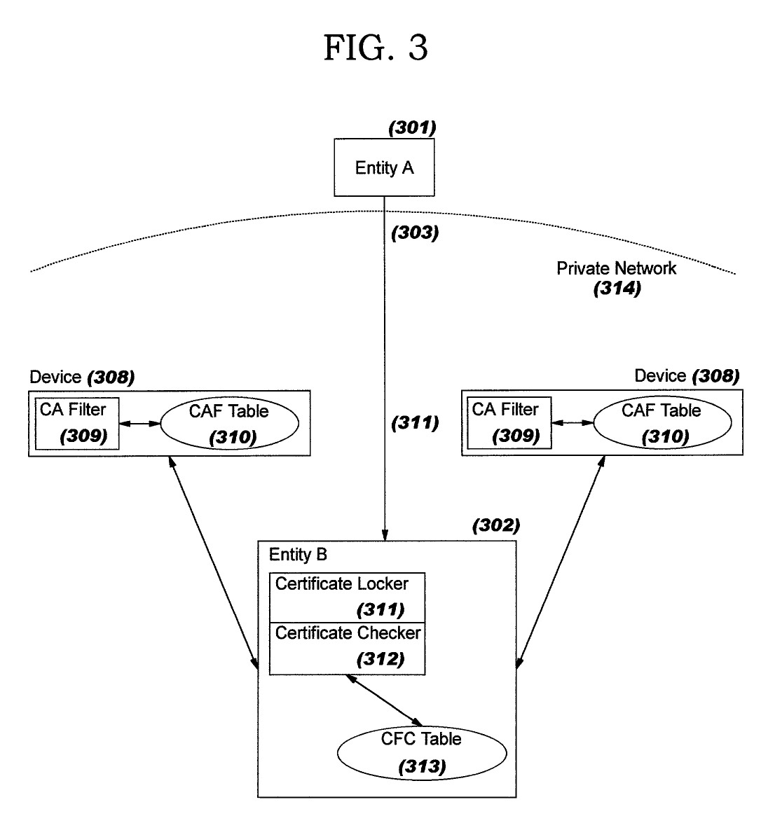

FIG. 3 describes the different entities involved in the method and system disclosed in the present invention.

Entity A

The Entity A (301) (for instance any user or computer device) wants to communicate with the Entity B (302). For instance, Entity A is an external user and Entity B is a user within a company network. When Entity A sends (303) a message signed with a Certificate to Entity B, this signed message is first received by a Certificate Locker component (311) within Entity B (302).

Certificate Locker and Certificate Checker

The Certificate Checker may be considered as a subset of the Certificate Locker. The main purpose of the Certificate Locker (311) is to store the Certificate in a “frozen zone” for preventing any application from using it. A “frozen zone” (which may also be called “protected zone”) can be the quarantine area of an antivirus checker or of a dedicated application having the same function.

Then the Certificate Locker calls the Certificate Checker (312) to:

Identify the Certificate Authority (CA) that has issued the Certificate.

Verify whether or not the identified CA is a trusted CA. To do so, the Certificate Filter accesses one more CA Filters (309) using the information contained in a Certificate Filter (CFC Table) Table (313).

If the Certificate Authority is a trusted CA, the CA public key or self-signed Certificate is sent back to the workstation in order to authenticate the Certificate.

Depending on whether the Certificate Authority is a trusted CA or not, the Certificate Checker (312) informs the Certificate Locker (311) to delete the certificate if the Certificate Authority is not a trusted CA, let the Certificate remain in the “frozen zone” if the CA is not yet approved as a trusted CA, or retrieve the certificate from the “frozen zone” when the Certificate Authority that has affirmed the certificate is a trusted CA. In this case, the Certificate Checker verifies the certificate signature using the public key transmitted by the device (308) comprising the CA filter (309).

Certificate Checker

According to the present invention, the main purpose of the Certificate Checker (312) is to retrieve, from one or more CA Filters, a trusted Certificate for a particular CA.

For each call of the Certificate Locker, the Certificate Checker performs the following operations:

retrieving the identifier of the Certificate Authority that has issued the received Certificate from the Issuer field of the received Certificate;

verifying the identity of the Certificate Authority; and

if the Certificate Authority is a trusted CA, retrieving from one or more Certificate Authority Filters, a trusted Certificate.

Typically, the Certificate Locker (311) and the Certificate Checker (312) are set up on a user workstation (302), or on any existing computer system adapted to provide the Certificate Locker and the Certificate Checker functions.

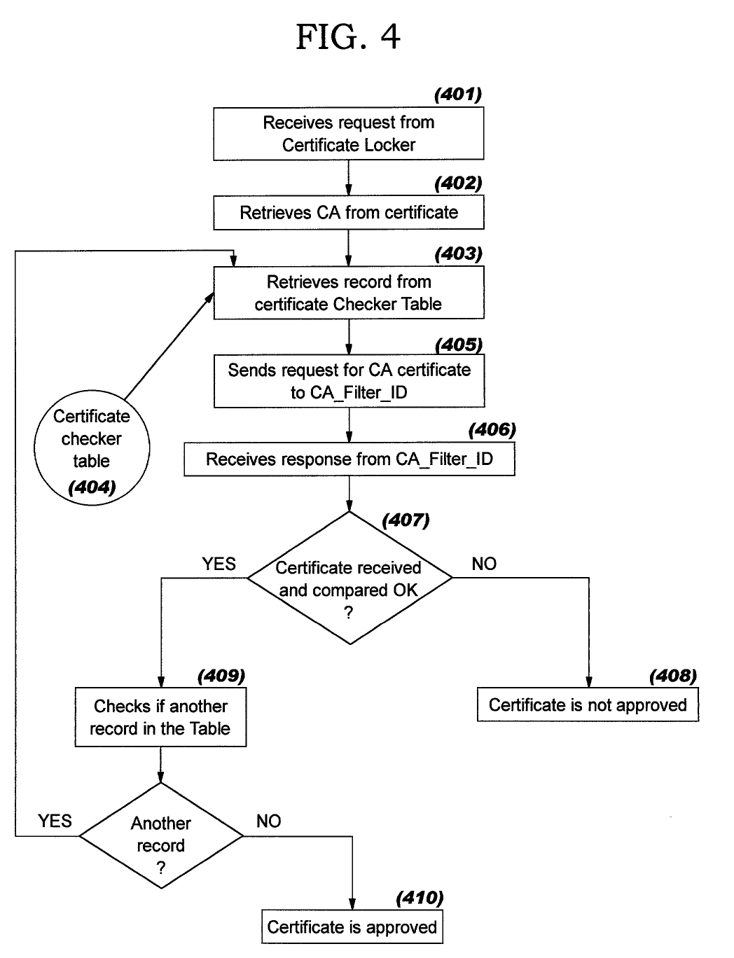

FIG. 4 is a flow chart which describes the internal logic of the Certificate Checker according to the following steps:

(Step 401): receives a request from the Certificate Locker. The Certificate Locker has received a signed message comprising a message Certificate, and this message Certificate has been stored in a “frozen zone”.

(Step 402): retrieves the name or the identification (called CA_Id) of the CA that has issued the received message Certificate. The Certificate Authority is identified using the “Issuer” field (102) of the message Certificate.

(Step 403): retrieves a record (602) from the Certificate Checker Table (404). The record includes:

“CA_Filter_Id”, which is an identification of a Certificate Authority Filter (309).

(Step 405): sends a request for a CA Certificate (or at least a CA public key) to the CA Filter identified by CA_Filter_Id.

The request for CA Certificate comprises:

The type of the request (called “Request_Type”). This field is set to the value “Full” to request the CA Certificate (or at least the CA public key) in the response. Otherwise no CA Certificate will be returned in the response.

The CA identifier (called “CA_Identifier”) equal to CA_Id

(Step 406) receives the response to the request. The response comprises the level of trust (called “Level_of_Trust”) of the CA identified by CA_Id. Depending on the level of trust, the response also comprises the CA Certificate (or the CA public key) associated with the Certificate Authority. Since the “Request_Type” of the request was set to “Full”, the CA Certificate is present in the response if the CA Filter found it. Otherwise no CA Certificate is returned in the response.

(Step 407) checks in the response:

the level of trust;

whether or not the CA certificate is received; and

whether or not the CA certificate is identical (the comparison is then OK) to the other CA certificates, if any, that have been previously retrieved from other CA Filters. The other CA certificates, if any, have been previously temporarily stored (in step 409) in the Certificate Checker Table.

If the level of trust corresponds to the level of trust of a trusted CA and if the CA Certificate is identical to other CA Certificates (OK):

(Step 409) checks whether there is another record (602) in the Certificate Checker Table (step 404).

temporarily stores the received CA Certificate for a later comparison (in step 407) if multiple CA Filters are defined in the Certificate Checker Table.

If there is another record in the table:

(Step 403): retrieves the next record (602) from the Certificate Filter Table.

If there is no other record in the table:

(Step 410): informs the Certificate Locker that the message Certificate can be retrieved from the “frozen zone” and be validated.

waits for the next request to process.

If the level of trust does not correspond to the level of trust of a trusted CA, or if the CA Certificate is not identical to other CA Certificates (KO):

(Step 408) informs the Certificate Locker to discard the received message Certificate stored in the “frozen zone”.

waits for the next request to process.

In other words, three cases can be considered (the third one is optional):

1. If the level of trust assigned to the certificate authority by each certificate authority filter (309) corresponds to the level of trust of a trusted Certificate Authority, the certificate checker:

compares the CA certificates (or at least the public keys) received in the responses:

if all the received CA certificates are identical,

(Step 410): informs the Certificate Locker that the message Certificate can be retrieved from the “frozen zone” and validated.

waits for the next request to process:

if received CA certificates are not all identical,

(Step 408) informs the Certificate Locker to discard the received message Certificate stored in the “frozen zone”.

waits for the next request to process.

2. If the level of trust assigned to the certificate authority by at least one certificate authority filter (309) corresponds to the level of trust of an untrusted Certificate Authority, the certificate checker

(Step 408) informs the Certificate Locker to discard the received message Certificate stored in the “frozen zone”.

waits for the next request to process.

3. Optionally, if the level of trust assigned to the certificate authority by at least one certificate authority filter (309) is between the level of trust of an untrusted Certificate Authority and a trusted Certificate Authority (level of trust “likely” or “to be verified”), and if the level of trust assigned to the certificate authority by each of the other certificate authority filters (309) corresponds to the level of trust of a trusted Certificate Authority, the certificate checker

(Step 408) informs the Certificate Locker to let the message Certificate remain in the “frozen zone” in order to prevent any application from using it.

waits for the next request to process.

Preferably, a warning message is displayed on the screen of the workstation to inform the user that a received message has been discarded or that a CA authentication has been requested to CA filters Administrators.

CA Filter

In order to verify whether or not the CA is a trusted CA, the Certificate Checker (312) contacts (307) a CA Filter component (309). The CA Filter may be included within a device (308) which is preferably a dedicated and protected device such as a Certificate Authority (CA) internal to company network.

In a preferred embodiment, multiple and independent CA Filters are setup within the company network. In this case, the Certificate Checker verifies with each CA Filter if the CA is a trusted CA. The use of multiple CA Filters provides maximum effectiveness to the present invention, in particular when a CA Filter becomes corrupted (for instance when a CA Filter is attacked).

A CA Filter (309) is mainly a central repository comprising a list of trusted CAs with their associated Certificates. The repository is stored within a CA Filter Table (CAF Table) (310). The list of trusted CAs is periodically maintained, typically by a Security Administrator, according to some security guidelines specific to the company. For instance:

The company can accept only a very limited list of trusted CAs in order to minimize the security exposure in the event a well known CA is attacked and becomes malicious (the less trusted CAs, the lower the risk of security breakage is).

Any CA subjected to an attack is immediately removed from the list of trusted CAs.

The list of trusted CAs may depend on the destination of the signed message. For instance, some sensitive organizations within a company (such as the Legal Department) may be allowed (by company decision) to receive messages only if these messages are signed by some very specific CAs, while another organization within the same company may be allowed to receive messages signed with a wider list of trusted CAs. In this case, the degree of trust of a CA listed in the CAF Table depends on the destination of the signed message within the company. Optionally, various degrees of trust can be associated with each CA. For instance, a CA can be either:

“Trusted”: the CA is a trusted CA. The messages signed by this CA can be received within the company.

“Likely”: the CA is not a trusted CA but is likely a trusted CA (for instance, the administrative process checking the legitimacy of the CA is almost complete with success). In this case, messages signed with the CA are allowed or not depending on the company security policy. For instance, a company which has very strict security may decide to discard messages signed by this CA, while another company may allow messages signed by this CA.

“Untrusted”: the CA is not a trusted CA. In this case, all messages signed by this CA must be discarded.

CA Filter Table (CAF Table)

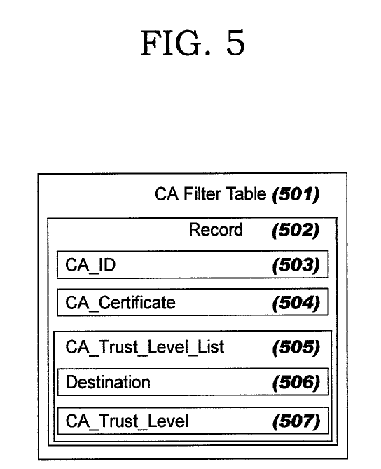

FIG. 5 describes the table used by the CA Filter (309). The table provides a list of trusted CAs, and for each CA, the associated Certificate. This table is called CA Filter (CAF Table) Table (310). The CA Filter Table (501) (a flat file in a preferred embodiment) is typically created by the Security Administrator in charge of the device (308) that includes the CA Filter component (308). The table is also typically maintained and periodically updated by the Security Administrator according to the security policy of the company. This table comprises for each CA the CA identifier, the CA Certificate, and information which indicates whether the CA is a trusted CA or not.

The CA Filter Table (501) comprises a list of records (502). There is one record for each CA, each record comprising the following information:

(503) CA_Id: this field comprises the identifier of the CA. Typically, this is the name of the CA which is defined in the Issuer field (102) of the Certificates issued by the CA.

(504) CA_Certificate: this field comprises the Certificate of the CA.

(505) CA_Trust_Level_L: this field comprises information indicating the level of trust of the CA. This information comprises two fields:

(506) Destination: this field comprises the identifier of a user or group of users. For instance, this may be a range of IP addresses. This is optional information. By default, the level of trust specified in the CA_Trust_Level field applies to any Destination.

(507) CA_Trust_Level: this is the level of trust of the CA, for the particular “Destination”. For instance, the CA may be “trusted” for one organization or one activity in the company and be “likely” for another organization or activity in the company. By default, the CA_Trust_Level field is set to the value “trusted”. Other values may be assigned to the CA Trust_Level field, for instance:

“Likely”: the CA is not yet trusted, but is in the process to be trusted (for instance, to be trusted, the CA waits for an administrative approval). Therefore, in some situations, the CA may already be considered as a trusted CA.

“Untrusted”: the CA is not trusted.

“To be Verified”: the CA is not trusted, but some Certificate Checkers (312) have requested the Certificate of this CA. The Security Administrator wants to verify whether such a CA can be trusted or not. The CA_Trust_Level field is updated to “trusted” or “untrusted” accordingly.

By default, CA_Trust_Level_L contains only one CA_Trust_Level which is then the level of trust of the CA identified by CA_Id.

Certificate Checker Table (CFC Table)

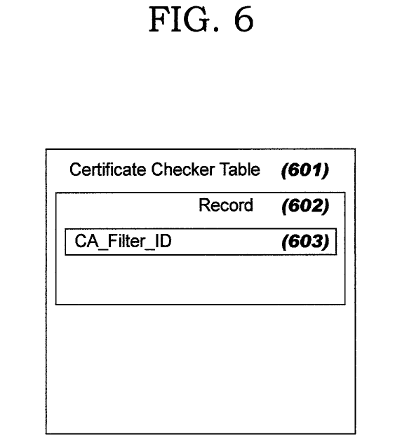

FIG. 6 describes the table used by the Certificate Checker (312). The table comprises the identifier of each CA Filter holding the list of trusted CAs within the company and their associated Certificates. This table is called the Certificate Checker (CFC Table) Table (313). The Certificate Checker Table (601) (a flat file in a preferred embodiment) is typically created by the Network Administrator in charge of the entities (for instance all user workstations) comprising a Certificate Checker (312). This table comprises the identifier of each CA Filter available for retrieving the Certificate of a specific CA. The Certificate Checker Table (601) comprises a list of records (602). There is one record for each CA Filter. Each record includes a (603) CA_Filter_Id, which is the identifier of the device (308) comprising the CA Filter. This is for instance the IP address of a computer system.

CA Filter

According to the present invention, the main purpose of the CA Filter (309) is to manage a list of CAs with their associated Certificates and levels of trust. The CA Filter is accessed each time information related to the level of trust of a particular CA must be retrieved. Each time the CA Filter receives a request for retrieving information related to the level of trust of a particular CA, the following operations are performed:

retrieving the level of trust associated with the CA from the CA Filter Table. Optionally, this step further comprises the step of selecting the level of trust from a list, according to the destination information sent within the request.

answering the request with the retrieved level of trust.

Typically, the CA Filter is either a dedicated network device (309), or an existing network device (for instance an IP Router) adapted to provide the Certificate Filter functions. However, the CA Filter is preferably a dedicated device which is used as an internal CA.

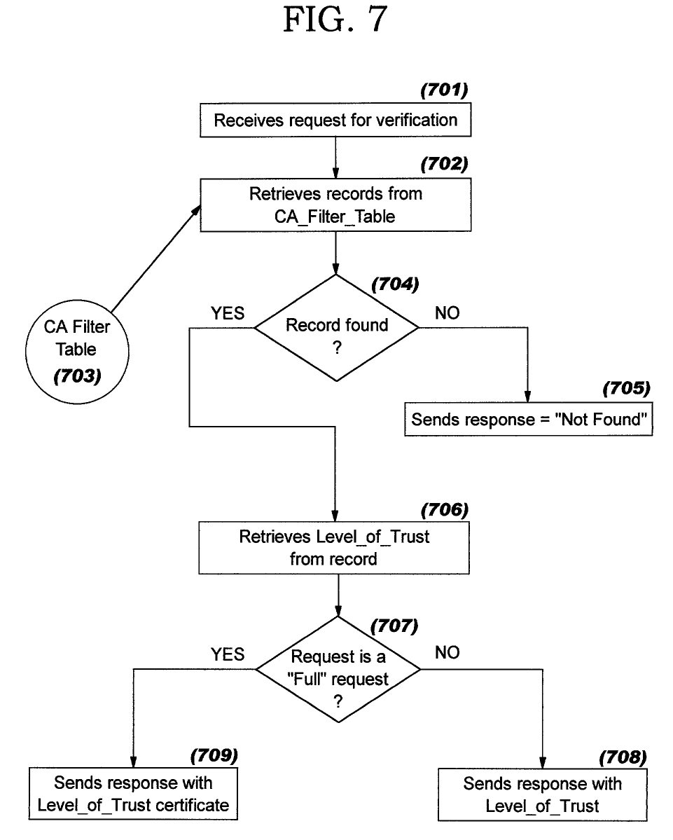

FIG. 7 is a flow chart which refers to the internal logic of the CA Filter. The CA Filter:

(Step 701): receives a request to verify a CA. Said request for CA verification comprises:

The type of the request (called “Request_Type”). The “Request_Type” field has preferably two values:

“Verification”: the request is a request to retrieve the level of trust of a particular CA.

“Full”: the request is a request to retrieve the Certificate of a particular trusted CA.

The CA identifier (called “CA_Identifier”) of the particular CA.

Optionally, the identifier (in a field called “Msg_Dest”) of one or a group of users (for instance the IP address of a particular user).

(Step 702): retrieves all records (502) from the CA Filter Table (703).

(Step 704): checks whether or not a record (502) corresponds to the CA identified in the request. This record is the record where the CA name or identifier “CA_Id” (503) in the CA Filter Table (501) is equal to the “CA_Id” received in the request.

If no record is found

(step 705) sends a negative response indicating that the level of trust of the CA identified in the “CA_Id” field was not found.

If a record is found

(step 706) retrieves the level of trust of the CA. The level of trust (in the field called “Level_of_Trust”) is extracted from the “CA_Trust_Level_L” (505) list within the record. “Level_of_Trust” is the value of the “CA_Trust_Level” (507) field associated with the “Destination” field which is equal to the “Msg_Dest” information received in the request.

If “Msg_Dest” is empty (this may happen because this is an optional information), the “Level_of_Trust” is equal by default to the first “CA_Trust_Level” field of “the CA_Trust_Level_L” list.

If the Request has a Request_Type=“Full”, (step 709) sends back a response comprising the “Level_of_Trust” and the “CA_Certificate” field of the record.

If the Request has a Request_Type not equal to “Full” (a Request_Type equal to “Verification”), (step 708) sends back a response comprising the “Level_of_Trust”.

Then wait for the next request to process.

While the invention has been particularly shown and described with reference to a preferred embodiment, it will be understood that various changes in form and detail may be made therein without departing from the spirit and scope of the invention.

1. A method for filtering certificates issued from one or more certificate authorities (CA), the method comprising the steps of:
receiving a certificate and storing the certificate;
preventing use of the certificate until validation;
identifying a certificate authority that has issued the certificate;
identifying a certificate authority filter by referring to a table, that comprises identification of at least one certifcate authority filter;
sending a request to the identified certificate authority filter;
receiving from the certificate authority filter a response to the request, the response comprising information related to the certificate authority that has issued the certificate and a public key of the certificate authority that has issued the certificate;
determining according to the response whether the certificate authority is a trusted certificate authority; and
validating the certificate if the certificate authority that has issued the certificate is a trusted certificate authority.

2. The method according to claim 1 further comprising the step of:
discarding the certificate if the response indicates that the certificate authority that has issued the certificate is not a trusted certificate authority.

3. The method according to claim 1, wherein the step of identifying the certificate authority that has issued the certificate comprises the further step of:
retrieving an identification of the certificate authority from the certificate.

4. The method according to claim 1, wherein the step of sending a request to the identified certificate authority filter comprises the further step of:
including in said request an identification of the certificate authority that has issued the certificate.

5. The method according to claim 1,
wherein the response received from the certificate authority filter comprises a level of trust assigned to the certificate authority, and
wherein the step of determining according to the response whether the certificate authority is a trusted certificate authority comprises the further step of:
checking whether the level of trust assigned to the certificate authority corresponds to a level of trust of a trusted certificate authority.

6. The method according claim 1 wherein the step of validating the certificate comprises the further steps of:
comparing the public key included in the response received from the certificate authority filter with a public key included in a response from a second certificate authority filter; and
validating the certificate if the public key included in the response received from the certificate authority filter is the same as the public key received in the response from the second certificate authority filter.

7. A method, in a certificate authority filter connected to a network, for filtering certificates issued from one or more certificate authorities, the method comprising the steps of:
receiving a request comprising an identification of a certificate authority;
identifying the certificate authority in said request;
finding in a table the certificate authority, the table comprising: identification of at least one certificate authority and a level of trust and a public key associated with each of said at least one certificate authority;
determining a level of trust of the identified certificate authority referring to said table;
retrieving a public key associated with the identified certificate authority referring to said table; and
sending a response to an originator of the request, said response comprising the level of trust of the identified certificate authority and the public key associated with the identified certificate authority.

8. The method according to claim 7 wherein said request further comprises an identification of a destination entity.

9. The method according to claim 8, wherein:
the table further includes, associated with the certificate authority, the destination entity and a level of trust associated with the destination entity; and
wherein the step of determining the level of trust further includes the step of determining the level of trust associated with the destination entity by referring to the table.
